(19) United States
(12) Patent Application Publication
(10) Pub. No.: US 2020/0407287 A1
(43) Pub. Date: Dec. 31, 2020

(54) CONTAINER FOR COMPOSTING

(71) Applicant: EXEL INDUSTRIES, Epernay (FR)

(72) Inventor: Pierrick LANCIEN, Paris (FR)

(73) Assignee: EXEL INDUSTRIES, Epernay (FR)

(21) Appl. No.: 16/975,779

(22) PCT Filed: Jun. 27, 2018
(86) PCT No.: PCT/EP2018/067296

§ 371 Date: Aug. 26, 2020

(30) Foreign Application Priority Data
Feb. 27, 2018 (FR) 1851716

(51) Int. Cl. C05F 17/986; B01F 7/00; B01F 7/32; B01F 15/00; B01F 13/02; C05F 17/907; C05F 17/993

(52) U.S. Cl. CPC C05F 17/986; B01F 7/00583; B01F 7/32; B01F 15/00974; B01F 2215/0054; B01F 15/00194; B01F 15/00188; C05F 17/907; C05F 17/993; B01F 13/0211

(57) ABSTRACT

A sleeve for the construction of a hose pipe extends about a longitudinal axis. The sleeve has greater elongation capacities in one direction than in the other with respect to the longitudinal axis.

### TECHNICAL FIELD

The present invention relates to a container for composting. This container is intended to accommodate solid materials, generally of plant origin, and/or liquids to allow them to decompose in a manner to produce natural phytosanitary products, also called purins or liquid compost.

### DESCRIPTION OF RELATED ART

In the field of compost containers, it is known to use a generic container able to accommodate the composting material. This container can be equipped with a lid. In practice, this container is typically a bucket, a trash can, or any equivalent container.

There are different methods of producing compost which may be roughly categorized as producing solid compost and liquid compost. This invention described herein relates to producing liquid compost. Generally, the method of making liquid compost includes breaking down organic material in a liquid, such as water. After the materials have broken down, the water that is infused with the byproducts from the decomposed material is used, for example, in gardening. Liquid Compost produces a high number of beneficial microbes which has been identified as supportive of healthy plants and/or vegetables growing within a domestic garden environment.

Typically, the method of producing liquid compost includes at least one stage to introduce the composting materials, at least one waiting stage, at least one stirring stage, if appropriate, a dosage stage providing at least one material, so that the fermentation process can be carried out, at least one filtering step, and/or at least one draining step to separate the solid and liquid products for using the product or products from the composting process.

In the aforementioned method, the stirring step is conventionally performed by removing the lid to open the container to access the content and then stirring the contents with a stick or equivalent. Such an operation causes a risk that an operator may be splashed with composting materials while stirring which may be undesirable because the composting materials are usually malodorous.

### SUMMARY

The present invention overcomes these various disadvantages and provides a container that is dedicated to composting and facilitates all or part of the operations to be performed. In particular, the invention provides a compost container comprising a tank and a lid, a stirrer configured to stir the contents of the tank and a filtering basket that is configured to filter the contents of the tank.

Due to the configuration of the compost container, an operator may perform a composting process with minimal interaction with the composting materials inside of the container.

The stirrer may be adapted to be operated manually and/or electrically from the exterior of the container, preferably when the container is closed. This facilitates the operator being able to stir the contents of the container while the container is closed.

The stirrer may comprise a mechanical device, such as a mobile whisk, capable of sweeping, at least partially, the interior volume of the tank. This configuration helps ensure that the contents in the filtering basket are a homogeneous mixture as well as help drain the liquid therein.

The stirrer may comprise a pneumatic device adapted to inject air at the bottom of the tank. This configuration also helps ensure that the contents in the filtering basket are a homogeneous mixture as well as help drain the liquid therein.

The stirrer may comprise at least one finger. The at least one finger may be adapted to sweep the interior volume of the tank. This configuration of having at least one finger also helps ensure that the contents in the filtering basket are a homogeneous mixture as well as help drain the liquid therein. Configuring the at least one finger to sweep the contents in the tank further aids in mixing the contents in the tank.

The at least one finger may be tapered, optionally, at least two fingers having substantially the same radial distance from the vertical center axis and are equally distributed. The tapering helps the operator insert the fingers into the content in the filtering basket and providing two fingers help ensure that the content is kept as a homogeneous mixture as well as facilitate ease of stirring for the operator.

The filtering basket may be adapted to be disposed within the tank. This configuration allows the filtering basket to be nested within the tank.

The container may further comprise a draining port that may be configured to maintain the filtering basket at least partially outside and above the tank. This configuration facilitates filtering the liquids from the filtering basket.

The filtering basket may comprise a grip arranged to be accessible when the filtering basket is arranged inside the tank, wherein the grip is preferably retractable. This grip facilitates insertion and removal of the filtering basket in the tank. The retractable grips allow the filtering basket to be contained inside of the enclosure formed by the tank and the lid.

The container may further comprise a scale for weighing the content. This is beneficial because it aids the operator in determining the correct amount of content to add and the correct proportions of organic material to water.

The scale may comprise a mechanical scale or a scale, integrated in the container or the filtering basket. Providing a mechanical scale is a cost effective may to provide a scale in the container.

The container may further comprise a volume measurer for measuring the volume of the content in the container. This is beneficial because it also aids the operator in determining the correct amount of content to add and the correct proportions of organic material to water.

The volume measurer may comprise a gauge, a float, or a scale. Providing a gauge, float, or scale is a cost effective may to provide a scale in the container.

The container may further comprise a gas detector, preferably accompanied by a control accessible from the exterior of the container. This is beneficial because detecting the presence of gas can aid an operator in determining the stage of the composting process as well as if a problem exists with the system by detecting an absence of gas.

The lid may be sealed, and may preferably comprise a lock to resist pressure. This seal can prevent unpleasant malodorous gases from escaping the container and reaching the operator.

The container may further comprise a draining port disposed at a height relative to the bottom of the tank and/or preferably further comprising an emptying port disposed at the bottom of the tank. The draining port allows an operator to selectively discharge any liquid that has accumulated in the container without having to remove the lid from the tank. This can be performed during the composting process or when the composting process is completed. Additionally, the emptying port can be used to help void the tank of the remaining liquids without having to remove the lid from the tank.

The filtering component may be configured to rest on top of an upper portion of the tank, while in a drainage configuration. This is beneficial because it facilitates draining of the filtering basket as well as providing a configuration that can perform the draining operation with minimal operator interaction.

The lid may include a translucent portion. This is beneficial because during the fermentation process, or when the contents are “brewing”, bubbles are formed on the surface of the liquid. The bubbles stop forming when the fermentation process is finished. Thus, the checking translucent portion allows an operator to determine if the fermentation process is finished without opening the container.

### BRIEF DESCRIPTION OF THE DRAWINGS

As used in this disclosure and the appended claims, the singular forms “a”, “an”, and “the” include plural referents unless the content clearly dictates otherwise. As used in this disclosure and the appended claims, the term “or” is generally employed in its sense including “and/or” unless the content clearly dictates otherwise. The following detailed description should be read with reference to the drawings. The detailed description and the drawings, which are not necessarily to scale, depict illustrative aspects and are not intended to limit the scope of the invention. The illustrative aspects depicted are intended only as exemplary.

FIG. 1 shows, in a perspective view, a container according to one embodiment of the invention;

FIG. 2 shows, in perspective view, the tank of FIG. 1 partially cut away;

FIG. 3 shows, in perspective view, a filtering basket according to one embodiment of the invention;

FIG. 4 shows, in perspective view, the filtering basket of FIG. 3 partially cut away;

FIG. 5 shows, in perspective view, an embodiment of a weighing means;

FIG. 6 shows, in perspective view, an embodiment of a stirring means;

FIG. 7 shows, in perspective view, another embodiment of a stirring means;

FIG. 8 shows, in a perspective view, a container according to an embodiment of the invention;

FIG. 9 shows an exploded view of the container of FIG. 8; and

FIG. 10 shows a perspective view of the container, with the filtering basket in a suspended state, in which it rests on the edge of the tank.

### DETAILED DESCRIPTION

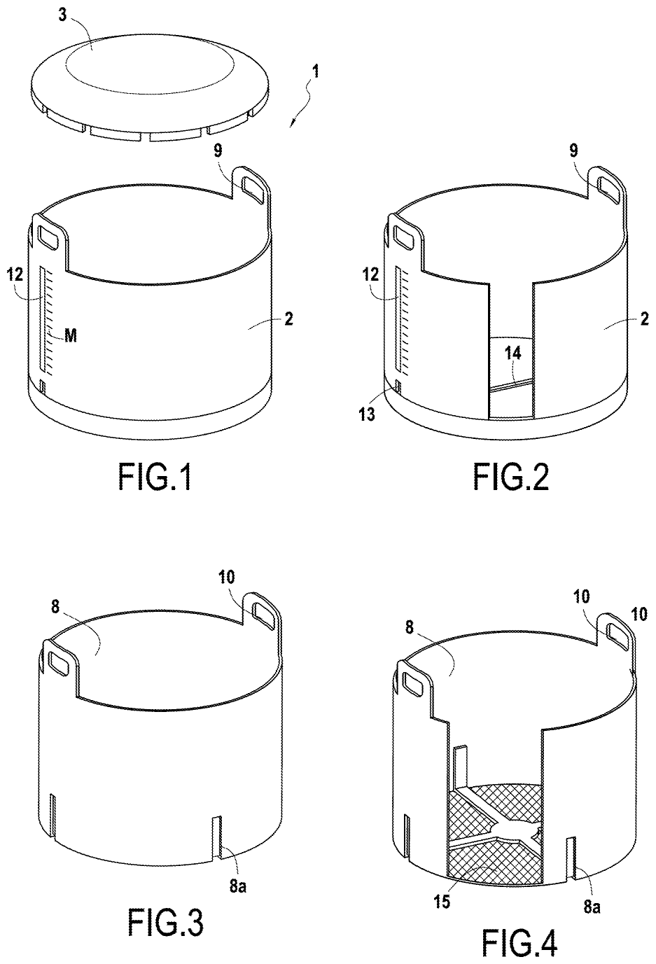

FIG. 1 shows a container 1 with compost according to the invention. The container 1 may comprise a tank 2 and a lid 3. The tank 2 may be configured to receive materials to be composted. These materials may be solid and liquid. For example, the solid materials may be solid organic materials, in particular, plants. These plants may be, for example, comfrey, nettles, ferns, horsetail, lavender, dandelions, burdock, tansy, absinthe, etc. These solid materials may be mixed with water. Additionally, the tank 2 is preferably liquid tight. In particular, the tank is for making liquid compost, thus it is advantageous to keep the liquid inside of the tank until an operator is ready to remove the liquid. Especially during the stirring process, that is described in more detail below. In order to be able to easily introduce the materials, the opening of the tank 2 is advantageously wide. The lid 3 is adapted to fit over this opening such that the lid 3 and the container 1 can form an enclosure.

For composting materials that are introduced into the container 1, typically the step that uses the longest amount of time during the composting process is waiting for the introduced materials to ferment.

Additionally, during different stages of the fermentation process, it is generally useful to stir the contents that are fermenting to mix the contents such that they can be homogenized. Also, according to an advantageous characteristic, the container 1 may further comprise a stirring means 4 configured to stir the contents in the tank 2.

Generally, at the end of the composting process, it is useful to separate the solid and liquid byproducts. This can be achieved by providing a filter. This is because the solid and liquid byproducts may not be used in the same way Therefore, according to an advantageous characteristic, the container 1 may comprise a filtering basket 8 configured to filter the contents of the tank 2.

In order to avoid the aforementioned disadvantages of manually stirring the contents of an open tank, the stirring means 4 is advantageously configured to be actuated from the exterior of the container 1. According to a preferred characteristic, this actuation is realized while the container is closed. This configuration diminishes the risk of an operator having the contents of the container splashing on them.

According to one embodiment, the actuation of the stirring means 4 is implemented manually by an actuator, for example, a handle disposed on the exterior of the tank 2 or lid 3. Alternatively, according to another embodiment, the actuation of the stirring means 4 may be implemented electronically by an actuator, such as a motor, which can be of any type, for example an electric DC motor. This can be controlled from outside of the tank 2 and lid 3 by including, for example, a switch on the lid 3 or exterior wall of the tank 2, or providing a remote.

The stirring means 4 may have any suitable form. For example, as shown in FIG. 6, which illustrates a first embodiment, the stirring means 4 may comprise a whisk disposed under the lid 3 so as to plunge into the tank 2 when the lid 3 is secured onto the tank 2. The actuating means 6, which may be in the form of a handle, may be disposed on the exterior of the lid 3 and/or tank 2. As can be seen, the lid 3 is configured to permit the actuation of the whisk from the exterior of the container 1 within the enclosure that is formed by the tank 2 and the lid 3. Similar to a salad spinning mechanism, the stirring means 4 may comprise a central rotary undercap that rotates relative to a ring. The ring may be fixed to the tank 2. The undercap may be rotated relative to the ring by an operator manipulating the handle 6. Additionally, a first gear (not visible) may be configured to engage a second gear on the lid 3 to drive a rotation of the whisk. The motion of the undercap and the wisk achieves a double rotation: a first rotation around the periphery of the undercap and a second rotation of the whisk about its axis. During this double movement, the whisk sweeps, partially or completely, the contents in the internal volume of the tank 2 to ensure that the contents are mixed. Such a mechanical device may be used primarily and/or by means of an actuator, such as a motor.

FIG. 7 illustrates another embodiment. The stirring means 4 may comprise a pneumatic device that is configured to inject air into the lower portion of the tank 2. This injected air, may be in the form of bubbles or streams. This injected air will stir the contents in the tank 2 while traversing from the lower to an upper portion of the tank 2. As shown, the stirring means 4 may comprise a diffuser having any appropriate shape, for example a diver forming a cross that is configured to be positioned near the lower portion of the tank 2. This diffuser may comprise a pipe that is configured to guide air from the exterior of the container 1. Further, the diffuser may have a plunger that is configured to be arranged at or near the bottom of the tank 2, under the contents inside of the tank 2. The plunger may have perforations 4a that are configured to allow the injected air to escape into the tank 2. The stirring means 4 may further comprise a pump 7 that is configured to inject the air into the diffuser. This pump may be operated manually, for example, similar to, and be a bicycle pump actuated by a movement, for example, linearly reciprocating a handle. Alternatively or additionally, the air injection can be performed by a compressor or any other suitable means, for example electrically driven devices.

The container 1 may further comprise a filtering basket 8 having a filter 15. This filtering basket 8 is advantageously a container that may be at least slightly smaller than the tank 2 such that it can be disposed entirely inside the enclosure formed by the tank 2 and the lid 3.

This filtering basket 8 comprises, on at least a portion of at least one of its surfaces, at least one perforation in order to filter the solid and liquid materials by allowing the liquids to flow through the filter 15 and out of the filtering basket 8 while retaining the solids. The size of the at least one perforation is a function of the size of the solid components that are intended to be retained in the filtering basket 8. For example, the area of the at least one perforation may be in a range of 0.001 cm² and 2 cm².

According to an embodiment, and as shown in FIG. 4 and visible as a sectional view, the bottom of the filtering basket 8 comprises, substantially all, the filter 15 made by perforations that are formed on the bottom or by any other type of filter, for example, a lattice or mesh. The presence of at least one perforation in the bottom of the filtering basket 8 advantageously makes it possible to completely separate the liquid materials from the solid materials.

In order to facilitate the filtering operation, without requiring the operator to keep the filtering basket 8 above the tank 2 during the entire filtering operation, the container 1 comprises, according to a first embodiment, a means for draining. Such means, for example comprises at least two stops integral with the inner wall of the tank 2, preferably retractable, and adapted to maintain the filtering basket 8 in an at least partially raised position above the bottom portion of the tank 2.

According to another embodiment, a draining means may also be produced by providing a filtering basket 8 and tank 2 with a substantially circular cross-section. For example, the filtering basket 8 and the tank 2 may have interlockable sections 8a, such that the filtering basket 8 can contact or be near the bottom of the tank 2 when in a first orientation. While in a second orientation, the interlocking sections are angularly offset about a vertical center axis, such that the filtering basket 8 and the tank 2 are prevented from interlocking. In this second orientation, the filtering basket 8 is not in contact with the bottom, but is suspended above the bottom of the tank 2.

These interlocking sections may be corresponding ribs and grooves 8a respectively formed on the interior surface of the tank 2 and the exterior surface of the filtering basket 8. For example, the tank 2 may have a set of 4 ribs disposed therein and the filtering basket 8 may have a corresponding set of 4 grooves 8a. The ribs and grooves 8a may have any length. For example, the ribs and grooves 8a may hold the filtering basket 8 half way through tank 2 when in the second orientation or ribs and grooves 8a may hold the filtering basket 8 substantially at a top portion of the tank 2 when in the second orientation.

In another example, the filtering basket 8 and tank 2 may have an elliptical shape. In a first orientation of the filtering basket 8 relative to the tank 2, the filtering basket 8 may fit within the tank 2 (e.g., when the major axes of the tank 2 and filtering basket are aligned); however in a second orientation the filtering basket 8 may rest at a top surface of the tank 2 (e.g., when the major axis of the filtering basket 8 is aligned with the minor axis of the tank 2).

According to another characteristic, the filtering basket 8 may comprise a gripping means 10 that may be arranged to be accessible to the operator when the filtering basket 8 is disposed inside the tank 2. The gripping means 10 may be, for example, a pair of handles and may be retractable. The gripping means 10 may be advantageously arranged at the top of the filtering basket 8 so that the operator can avoid contacting the content of the tank 2.

Additionally, the container 1 may advantageously comprise gripping means 9, to facilitate the transportation of the container. The gripping means 9 may be, for example, at least one handle and preferably a pair of handles.

It may be useful during certain stages of the composting process to be able to dose a material added to the container 1. For example, a chemical may be added to the material to facilitate the fermentation process. The chemical may be a grain, powder, or pellet form and may be a yeast or an activator. A measuring device such as a measuring cup or a measuring spoon may be used to measure the required “dose” needed for each batch of compost. This is, for example, the case when the materials are initially introduced at the beginning of the process. This can also be the case during a process when a material has to be added or completed, such as an additional or complementary material. This may also relate to a fermentation activator (bacteria, yeasts or ferments) introduced initially or during the fermentation process.

This dosage may be advantageously carried out by weighing the material. Weighing is more particularly suited to the dosage of solid materials, but may also be suitable for liquid materials. Weighing may be advantageously carried out by implementing a mechanical or electronic scale. This scale 11 may then be integrated into the container 1. For example, the scale may be arranged between the container and the tank to measure the load of the entire container 1 between the tank 2 and the ground. In another example, the scale 11 may be configured to measure the load in the filtering basket 8 by integrating the scale 11 between the tank 2 and the filtering basket 8. However, in another example, the scale 11 may also be configured to measure the load in the filtering basket by integrating the scale 11 between the lid 3 and the filtering basket 8. Alternatively, this scale can be integrated in the filtering basket 8 and be configured to measure the force between the filtering basket 8 and the tank 2, where this force may be used to determine the weight of the contents of the filtering basket 8.

According to an inexpensive and alternative embodiment, the weighing means 11 may comprise a mechanical scale. As previously described for the scale 11, this scale may be integrated into the container 1 similar to the aforementioned examples.

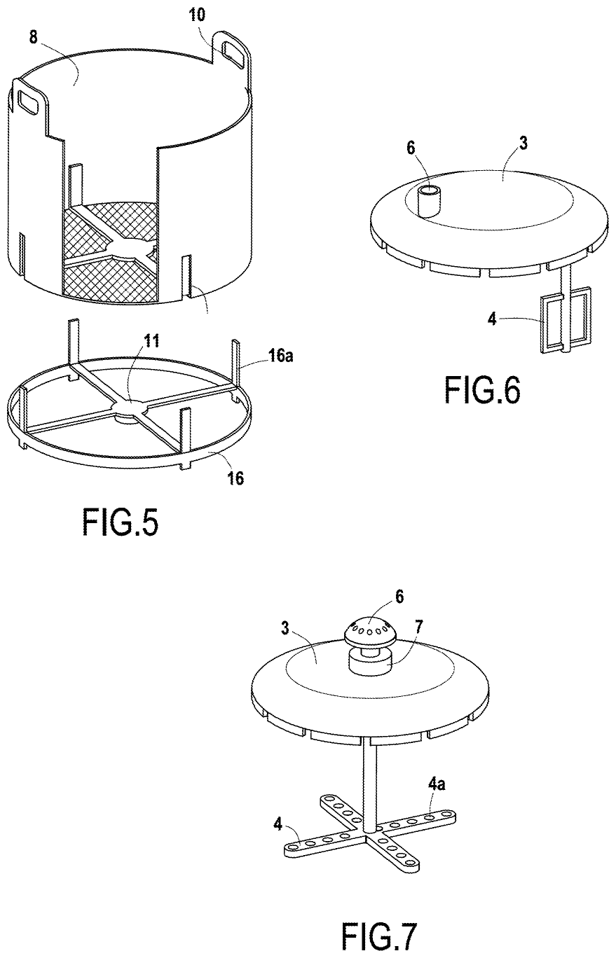

According to another embodiment, as illustrated in FIG. 5, the mechanical scale 11 may be integrated in the filtering basket 8. The mechanical scale 11, which may be in the form of an elastic compression means, such as a compression spring, may be arranged under the filtering basket 8. It may be compressed by the filtering basket 8 against the bottom of the tank 2 or against a support 16 when the filtering basket 8 is loaded with material. The crushing of the scale 11 may help determine the weight of the contents in the filtering basket 8. The support may also have an interlocking portion 16a that is adapted to interlock with the interlocking portion 8a of the filtering basket 8.

A graduation may be disposed between the filtering basket 8 and the support 16 or the tank 2 which may make it possible to convert a height of the filtering basket 8 relative to the tank 2 into a weight of the contained material.

The support 16 may be used as the weighing means 11 in the absence of the tank 2 by placing the filtering basket 8 on the support 16 on the ground. In this case, the graduation may be advantageously arranged on the filtering basket 8 in relation to any one of the slides of the support 16.

A graduation at the top of the inner wall of the tank 2 may, additionally or complementarily, allow weighing when the filtering basket 8 is in the tank 2.

A volume measuring means 12 may also be advantageous for performing the dosing of the liquid materials. Such a means 12 may be advantageously integrated with the container 1, preferably at the level of the tank 2 or alternatively with the filtering basket 8.

The means for measuring the volume 12 may be any suitable means. According to a preferred embodiment, the volume measuring means 12 may comprise a gauge, float, or scale.

A gauge 12 is illustrated in FIGS. 1 and 2. In an embodiment of the tank 2, the tank 2 may be made of a plastic material. Further, at least a portion of a wall of the tank 2 may be at least partially translucent, advantageously extending over substantially the entire height of the tank 2. A suitable graduation may be disposed opposite to the translucent portion on the outer wall of the tank 2. This graduation may comprise said gauge and may be configured to convert a height of liquid in the tank 2 into a volume. The markings M of the graduation may vary depending on the size of the container 1, but may be spaced apart in the order of 0.1 liter.

Alternatively or additionally, the gauge may also be used as a float, and be configured to float on the surface of the liquid so as to indicate the height of said surface.

Alternatively or additionally, the gauge may also be used as a scale. It may be necessary to know the density of the liquid in order to be able to convert the measured weight into a volume. However, if the liquid that is used has similar properties as water, at least in terms of weight and density, the properties of the liquid can be taken as equal to the properties of water.

An advantage of using a scale is that the scale may be advantageously reused for weighing and for volume measurement, possibly by performing a calibration and/or configuration change between a weighing operation and a volume measurement operation.

Depending on the composting process envisaged, it may be advantageous to determine the presence or absence of a gas. Such a determination may indeed be indicative of the completion of a step or process and provide useful information to the operator. Also, the container 1 may also advantageously comprise a means for detecting a gas. Such a detector may, for example, comprise a means for sensing a pressure difference. This detection means may be preferably coupled to a control, binary or proportional, that may be advantageously accessible from the exterior of the container 1, so that it may be read without opening the container 1.

The composting process may generate a malodorous gas, thus the lid 3 may be advantageously gastight. Depending on the pressures envisaged, it is preferably equipped with a locking means configured to resist pressure. Alternatively, the container 1 may comprise a pressure relief valve.

At the completion of the composting process, it is appropriate to obtain the liquid byproducts. This can be done before or after filtering is completed. Thus, container 1 may further comprise a draining port 13, which is visible in FIG. 2. This port 13 may be closed by a plug or a tap. According to one embodiment, the draining port 13 may be arranged at a height relative to the bottom of the tank 2. In particular, the distance between the bottom of the tank 2 and the discharge port 13 may be in a range of 1 and 10 cm. This distance allows for leaving a volume of liquid at the bottom of the tank. This volume of liquid may contain unwanted products or particles that were small enough to pass through the filer.

According to an embodiment, and as shown in FIG. 2, the bottom of the tank 2 may further comprise a channel 14 capable of receiving the particles, i.e., highly viscous liquid.

The container 1 may further comprise an emptying port (not shown) disposed at the bottom of the tank 2. This port may be closed by a stopper or a tap. This emptying port may allow for the complete emptying of the tank 1 after the tank 2 is drained via the draining port 13. However, it may be used in place of the draining port 13.

The draining port 13 and/or the emptying port may be advantageously equipped with a standard gardening type connection for connection to, for example a watering device for spreading nutrients on the ground or soil.

After draining/emptying the liquid products from the container 1, the solid products may also be recovered and be used as an activator for future compost or a slow diffusion fertilizer which can be buried.

In order to facilitate cleaning the container 1 after use, the container 1, and all its constituents, may advantageously have smooth surfaces and shapes that are free of recesses and or crevices.

The container 1 can be made of any material, for example, a plastic such as polypropylene which is cost efficient, easy to clean, resists staining, and is also UV stable which allows the container to be stored outdoors and maintain its color. Additionally, the lid 3 may have a checking portion to allow an operator to see the contents inside of the container 1 either by opening a small door or having a transparent portion without having to open the container 1. For example, this may be achieved by including an openable door that is rotatably attached to the lid 3 or tank 2. The door may have a transparent portion underneath. In another example, a transparent window is provided without the door. This checking portion is beneficial because during the fermentation process, or when the contents are “brewing”, bubbles are formed on the surface of the liquid. The bubbles stop forming when the fermentation process is finished. Thus, the checking portion allows an operator to determine if the fermentation process is finished without removing the lid 3 from the container 1.

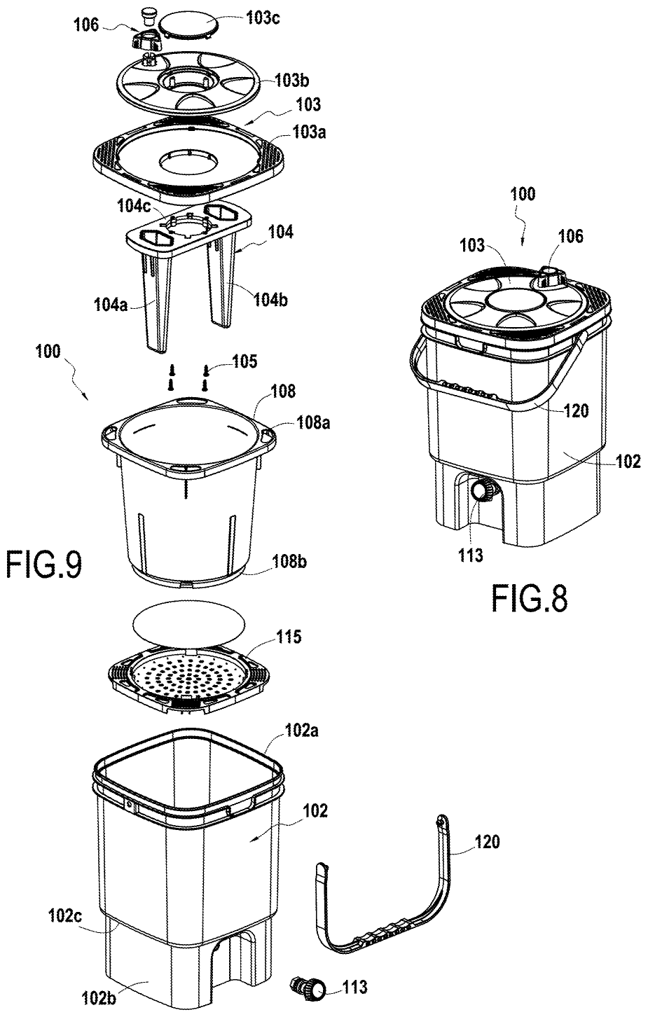

FIGS. 8 to 11 show a container 100 for composting according to another example. As can be seen, similarly to FIG. 1, FIG. 8 shows a container 100 with compost. The container may comprise a tank 102 and a lid 103. The tank 102 may be configured to receive materials to be composted. These materials may be solid and liquid. As aforementioned, the tank 102 is for making liquid compost, thus it is advantageous to keep the liquid inside of the tank 102 until an operator is ready to remove the liquid, especially during the stirring process. Thus, the tank 2 is preferably liquid tight. In order to be able to easily introduce the materials, the opening of the tank 2 is advantageously wide. The lid 3 is adapted to fit over the opening such that the lid 3 and the tank 2 can form an enclosure.

As aforementioned, during different stages of the composting process, it is useful to stir the contents. Thus, the container 100 may further comprise a stirring means 104 configured to stir the contents in the tank 102. In order to avoid the aforementioned disadvantages of manually stirring the contents of an open tank, the stirring means 104 is configured to be actuated from the exterior of the container 100. This configuration diminishes the risk of an operator having the contents of the container splashing on them, which is unpleasant.

According to this embodiment, the stirring means 4 may have at least one finger 104a that extends from an upper portion of the filtering basket 104a toward a lower portion 104b of the filtering basket 104. The finger 104a may be offset from a vertical center axis of the filtering basket 104. This is advantageous because the finger 104a, similar to the wisk 104, can sweep the interior wall of the filtering basket 104.

As shown in FIG. 9, the stirring means has two fingers 104a, 104b that extend from the top portion of the filtering basket 104a toward the lower portion of the filtering basket 104b. The fingers 104a, 104b are both offset from the vertical center axis of the filtering tank and are also diametrically opposed. Although one and two fingers are discussed, it is envisioned that any appropriate number of fingers may be used. However, it is also envisioned that if multiple fingers 104a, 104b, are implemented, each of the fingers 104a, 104b have the same radial distance from the vertical center axis and are equally distributed in the filtering basket 104b.

Each of the fingers 104a, 104b may be tapered such that the portions of the fingers that is closest to the upper portion 108a of the filtering basket 108 (e.g., the base) has a larger cross-section than the portion of the finger that is closest to the bottom portion 108b of the filtering basket 108. This tapering facilitates inserting the fingers 104a, 104b into the contents in the filtering basket 108. The fingers 104a, 104b may be hollow, however, it is also envisioned that the fingers 108a, 108b may be solid. The stirring means 104 may further include an attachment portion 104c. The attachment portion 104c may be formed as a plate. For example, the bases of the fingers 104a, 104b are fixed to the attachment portion 104c. The attachment portion may be monolithically formed with the fingers 104a, 104b, but it is also envisioned that they may be a sub-assembly.

Similar to container 100, the stirring means 104 is attached to the lid 103. The lid 103 has a ring 103a that can be fixed to the tank 102. The lid 103 and the tank 102 may have a gastight connection. The lid 103 further includes a rotary portion 103b that is rotatably attached to the ring 103a. A handle 106 may be attached to the exterior portion of the rotary portion 103b and the stirring means 104 may be attached to the interior portion of the rotary portion 103b. In particular, the rotary portion 103b may have an elongated skirt extending vertically through the ring 103a along the vertical central axis and toward the interior of the tank 2. The attachment portion 104c of the stirring means 104 may be attached to the lid 103 via the elongated skirt of the rotary portion 103b. This attachment may be achieved by a fastening means 105, for example, a set of screws, bolts, clips, etc.

Similar to container 100, when the handle 106 is actuated, the rotary portion 103b rotates which drives the stirring means 104 to rotate. In this configuration, the fingers 104a, 104b are configured to sweep the interior wall of the filtering basket 108 and mix the contents therein.

As mentioned above with reference to container 1, the lid 103 may have a checking portion 103c to allow an operator to see the contents inside of the container 100 without having to remove the lid 103 from the container 100. This is beneficial because during the fermentation process, or when the contents are “brewing”, bubbles are formed on the surface of the liquid. The bubbles stop forming when the fermentation process is finished. The checking portion 103c allows the operator to determine the stage of the fermentation process. Additionally, the composting process may generate a malodorous gas, thus the existence of the checking portion 103c is beneficial because the operator can check the fermentation process without being disturbed by a bad smell from the malodorous gas.

The checking portion 103c can be in any form, for instance, in the form of a circle or a disk (see also FIG. 9). In this example, the checking portion 103c is a transparent window. Any suitable materials may be used, for example a plastic that has a mechanical resistance adapted to resist to a force applied by the hand of the operator or be the same as the overall mechanical resistance of the lid.

The checking portion 103c may be integrated with the other components of the lid and thus irremovable, or it may be connectable with the other components of the lid, without being outside of the scope of the present invention. For example, the checking portion may be a openable door that is rotatable attached to the lid 103. Such openable door may have dimensions very significantly smaller than those of the lid, and may be opened and closed quickly. Therefore opening such door may lead to a small quantity of malodorous gas only being released, thus substantially avoiding nuisance possibly caused by such gas.

This checking portion may be achieved by including an openable door (not shown) that is rotatably attached to the lid 3 or tank 2. Another manner in which this may be achieved is by including a transparent window. As can be seen in FIGS. 8-10, the window may be formed in the lid 103 as a cap 103c

As aforementioned, at the end of the composting process, it is useful to separate the solid and liquid byproducts. Similar to filtering basket 4, the filtering basket 104 includes a filter 115. The filter 115 may be releasably connected to the bottom portion 108b of the filtering basket 108. The filter 115 may have at least one perforation for separating the liquid materials from the solid materials. The filter 115 may have a plurality of perforations. Additionally, a lattice or mesh may be positioned between the bottom portion 104b of the filtering basket 104 and the filter 115.

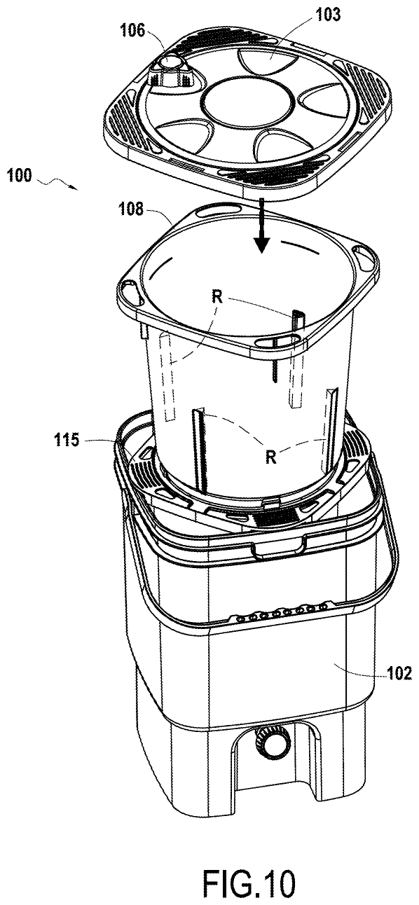

FIG. 10 shows a perspective view of the filtering basket 108. The interior surface of the filtering basket 108 has an obstruction portion R. This obstruction portion R grips onto the contents in the container 100 when the operator stirs the contents. This obstruction causes turbulence in the contents that effectively allows the contents to be mixed together rather than turn inside of the container 100 as a solid block. The obstruction portion R may be formed as a protuberance that extends toward the interior of the filtering basket 108. The protuberance may extend an entire height of the filtering basket 108 or at least a portion thereof. The obstruction portion R may be formed as at least one rib. The obstruction portion is arranged to leave large enough diametrical dimensions within the tank free of obstacle for movement of the stirrer.

As can be seen in FIG. 10, the obstruction portion R is formed as four V-shaped ribs. Although this is depicted as four V-shaped ribs, any number of ribs R may be used. Additionally, the ribs R may be formed to have any suitable shape, for example, a square or any other profile that has an edge.

As shown in FIG. 10, the tank 102 and filter 115 have substantially square shaped cross-sections that are alignable. This configuration allows the filtering basket 108 to rest on a top portion 102a of the tank 102 to facilitate emptying the filtering basket 104 of liquid. For example, in operation, an operator may grip the gripping portions of the filtering basket 108 to remove the filtering basket 108 from the inside of the tank 102. The filtering basket 108 may then be rotated about the vertical center axis such that the shape of the filter 115 and the shape of the opening of the tank 102 are misaligned thereby allowing the operator to balance the filtering basket 108 on top of the tank 2. Here, the squared ends of the filter serve as a retaining portion for maintaining the filtering basket 108 on the top portion 102a of the tank 102.

However, this is only an exemplary solution, the retaining portion not need be a square shaped filter 115. For example, similar to the corresponding ribs and grooves 8a of container 1, the top portion 102a of the tank 102 may include a lip or a shoulder as a retaining portion that when the filter 115 is in a desired orientation, the filtering basket 108 may be adapted to rest at or on the top portion 102a of the tank 102. Alternatively, the retaining portion need not be incorporated into the filter 115. For example, the retaining portion may be formed as a plurality of flanges that protrude from the exterior surface of the filtering basket 108.

The filtering basket 108 and tank 102 may be any suitable shape that can allow the filter container 108 to optionally be nested within the tank 102 or be set on top of the upper portion 102a of the tank 102. Further, the filter 115 of the filtering basket 108 may also include gripping portions that can allow an operator to grasp the filtering basket 108, in particular, while the filtering basket 104 is disposed on top of the tank 102. This configuration is similar to the container 1 where the filtering container 8 and the tank 2 have nesting elliptical shaped cross-sections.

In this configuration, the filtering basket 108 can rest on top of the tank 102 without the assistance of the operator. This is advantageous because this configuration allows the operator to option to “set it and forget it” or leave the filtering basket 108 on top the tank 102 until the filtering basket 108 is voided or substantially voided of liquid without having to interact with the container 100.

The tank 102 may further include a shoulder 102c that may be formed at a distance in a range of 1 and 10 cm from the bottom portion 102b of the tank 102. This shoulder 102c is configured to prevent the filter 115 from entering the bottom portion 102b of the tank 102. In this configuration, the liquid that passes through the filter 115 can collect in the bottom portion 102b of the tank 102.

Similar to tank 2 of container 1, the tank 102 further includes a draining port 113 in the bottom portion 102b of the tank 102. This draining port 113 can be opened to release liquid that is in the tank 102 or the draining port 113 can be closed to allow liquid to accumulate in the tank 102.

The tank 102 may further include a handle 120 that can help the operator move the tank 102 or the entire container 100.

Although the described embodiments were provided as different exemplary embodiments, it is envisioned that these embodiments are combinable or, when not conflicting, the features recited in the described embodiments may be interchangeable. For example, similar to what was described for container 1, the container 100 may further include a weighing means 11, a gauge, a float, a scale, an emptying port, a detection means, etc.

Throughout the description, including the claims, the term “comprising a” should be understood as being synonymous with “comprising at least one” unless otherwise stated. In addition, any range set forth in the description, including the claims should be understood as including its end value(s) unless otherwise stated. Specific values for described elements should be understood to be within accepted manufacturing or industry tolerances known to one of skill in the art, and any use of the terms “substantially” and/or “approximately” and/or “generally” should be understood to mean falling within such accepted tolerances.

Although the present disclosure herein has been described with reference to particular embodiments, it is to be understood that these embodiments are merely illustrative of the principles and applications of the present disclosure. It is intended that the specification and examples be considered as exemplary only, with a true scope of the disclosure being indicated by the following claims.

1. A compost container, comprising a tank and a lid, a stirrer configured to stir the contents of the tank and a filtering basket that is configured to filter the contents of the tank.

2. The container according to claim 1, wherein the stirrer is adapted to be operated manually and/or electrically from the exterior of the container, when the container is closed.

3. The container according to claim 1, wherein the stirrer comprises a mechanical device, such as a mobile whisk, capable of sweeping, at least partially, the interior volume of the tank.

4. The container according to claim 1, wherein the stirrer comprises a pneumatic device adapted to inject air at the bottom of the tank.

5. The container according to claim 1, wherein the stirrer comprises at least one finger.

6. The container according to claim 5, wherein the at least one finger is adapted to sweep the interior volume of the tank.

7. The container according to claim 5, wherein the at least one finger is tapered and at least two fingers having substantially the same radial distance from the vertical center axis and are equally distributed.

8. The container according to claim 1, wherein the filtering basket is adapted to be disposed within the tank.

9. The container according to claim 8, further comprising a draining port configured to maintain the filter container at least partially outside and above the tank.

10. The container according to claim 1, wherein the filtering basket comprises a grip arranged to be accessible when the filtering basket is arranged inside the tank, wherein the grip retractable.

11. The container according to claim 1, further comprising a scale for weighing the content.

12. The container according to claim 11, wherein the scale comprises a mechanical scale or a scale, integrated in the container or the filtering basket.

13. The container according to claim 1, further comprising a volume measurer for measuring the volume of the content in the container.

14. The container according to claim 13, wherein the volume measurer comprise a gauge, a float, or a scale.

15. The container according to claim 1, further comprising a gas detector, preferably accompanied by a control accessible from the exterior of the container.

16. The container according to claim 1, wherein the lid is sealed, and comprises lock to resist pressure.

17. The container according to claim 1, further comprising a draining port disposed at a height relative to the bottom of the tank and/or further comprising an emptying port disposed at the bottom of the tank.

18. The container according to of claim 1, wherein the filtering component is configured to rest on top of an upper portion of the tank, while in a drainage configuration.

19. The container according to claim 1, wherein the lid includes a translucent portion.

20. The container according to claim 1, wherein the filtering basket includes an obstruction portion and at least one element extending inwardly from the interior surface of the filtering basket.
